(19) United States
(12) Patent Application Publication
(10) Pub. No.: US 2026/0058943 A1
(43) Pub. Date: Feb. 26, 2026

(54) API INVOKING METHOD AND APPARATUS

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/110,112

(22) PCT Filed: Sep. 29, 2022
(86) PCT No.: PCT/CN2022/122958

§ 371 Date: Mar. 10, 2025

(51) Int. Cl. H04L 9/40; G06F 9/54

(52) U.S. Cl. CPC H04L 63/083; G06F 9/547; H04L 63/10

(57) ABSTRACT

An application programming interface (API) invoking method is executed by an API exposing function (AEF) entity. The method includes: receiving an API invoking request sent by an API invoking entity, and performing API invoking authentication based on API invoking information and a user resource access token. The API invoking request comprises the API invoking information and the user resource access token.

### CROSS-REFERENCE TO RELATED APPLICATION

This application is a US national phase entry of International Application PCT/CN2022/122958 filed on Sep. 29, 2022, the entire content of which is incorporated herein by reference.

### FIELD

The present disclosure relates to the field of communication technology, in particular to an API invoking method, an API invoking apparatus, a device and a non-transitory computer-readable storage medium.

### BACKGROUND

In a communication system, a common application programming interface framework (CAPIF) is introduced to achieve load balance and access control. The CAPIF includes an application programming interface (API) invoking entity, a common API framework core function (CCF), an API exposing function (AEF), etc. The AEF may provide one or more APIS.

However, the API invoking entity in the CAPIF may directly access, according to API information, the AEF providing the API, and invoke the API via the AEF. In this process, the AEF is not authorized by a resource owner, i.e., the AEF directly accesses a user resource without being authorized by the resource owner. Based on this, an API access resource may probably be invoked illegally, so the API invoking security may be deteriorated.

### SUMMARY

In a first aspect, the present disclosure provides in some embodiments an API invoking method, executed by an AEF entity, including: receiving an API invoking request sent by an API invoking entity, where the API invoking request includes API invoking information and a user resource access token; and performing API invoking authentication based on the API invoking information and the user resource access token.

In a second aspect, the present disclosure provides in some embodiments an API invoking method, executed by an API invoking entity, including: sending an API invoking request to an AEF entity, where the API invoking request includes API invoking information and a user resource access token.

In a third aspect, the present disclosure provides in some embodiments a communication apparatus, applied to an AEF entity, including: a reception module configured to receive an API invoking request sent by an API invoking entity, where the API invoking request includes API invoking information and a user resource access token; and an invoking authentication module configured to perform API invoking authentication based on the API invoking information and the user resource access token.

In a fourth aspect, the present disclosure provides in some embodiments an API invoking apparatus applied to an API invoking entity, including: a sending module configured to send an API invoking request to an AEF entity, where the API invoking request includes API invoking information and a user resource access token.

In a fifth aspect, the present disclosure provides in some embodiments a communication apparatus, including a processor. The processor is configured to invoke a computer program in a memory to implement the API invoking method in the first aspect.

In a sixth aspect, the present disclosure provides in some embodiments a communication apparatus, including a processor. The processor is configured to invoke a computer program in a memory to implement the API invoking method in the second aspect.

In a seventh aspect, the present disclosure provides in some embodiments a communication apparatus, including a processor and a memory. The memory is configured to store therein a computer program, and the processor is configured to execute the computer program in the memory to implement the API invoking method in the first aspect.

In an eighth aspect, the present disclosure provides in some embodiments a communication apparatus, including a processor and a memory. The memory is configured to store therein a computer program, and the processor is configured to execute the computer program in the memory to implement the API invoking method in the second aspect.

In a ninth aspect, the present disclosure provides in some embodiments a communication apparatus, including a processor and an interface circuit. The interface circuit is configured to receive a code instruction and transmit the code instruction to the processor, and the processor is configured to execute the code instruction to implement the API invoking method in the first aspect.

In a tenth aspect, the present disclosure provides in some embodiments a communication apparatus, including a processor and an interface circuit. The interface circuit is configured to receive a code instruction and transmit the code instruction to the processor, and the processor is configured to execute the code instruction to implement the API invoking method in the second aspect.

In an eleventh aspect, the present disclosure provides in some embodiments a communication system, including the communication apparatus in the third aspect and the communication apparatus in the fourth aspect, or including the communication apparatus in the fifth aspect and the communication apparatus in the sixth aspect, or including the communication apparatus in the seventh aspect and the communication apparatus in the eighth aspect, or including the communication apparatus in the ninth aspect and the communication apparatus in the tenth aspect.

In a twelfth aspect, the present disclosure provides in some embodiments a non-transitory computer-readable storage medium storing therein an instruction for the above-mentioned communication apparatus. The instruction is executed by the communication apparatus to implement the API invoking method in the first aspect or the second aspect.

In a thirteenth aspect, the present disclosure provides in some embodiments a computer program product including a computer program. The computer program is executed by a computer to implement the API invoking method in the first aspect or the second aspect.

In a fourteenth aspect, the present disclosure provides in some embodiments a chip system, including at least one processor and an interface, and configured to support a communication apparatus to achieve functions involved in the first aspect or the second aspect, e.g., determining or processing at least one of data or information involved in the above method. In a possible design, the chip system further includes a memory configured to store therein a computer program and data desired for the chip system. The chip system includes a chip, or includes a chip and other discrete elements.

In a fifteenth aspect, the present disclosure provides in some embodiments a computer program. The computer program is executed by a computer to implement the API invoking method in the first aspect or the second aspect.

### BRIEF DESCRIPTION OF THE DRAWINGS

The above-mentioned and/or other aspects and advantages of the present disclosure may become apparent and easily understandable in the following description in conjunction with the drawings.

FIG. 1 is a schematic diagram of a communication system according to an embodiment of the present disclosure.

FIG. 2 is a flow chart of an API invoking method according to an embodiment of the present disclosure.

FIG. 3 is another flow chart of the API invoking method according to an embodiment of the present disclosure.

FIG. 4 is yet another flow chart of the API invoking method according to an embodiment of the present disclosure.

FIG. 5 is still yet another flow chart of the API invoking method according to an embodiment of the present disclosure.

FIG. 6 is still yet another flow chart of the API invoking method according to an embodiment of the present disclosure.

FIG. 7 is still yet another flow chart of the API invoking method according to an embodiment of the present disclosure.

FIG. 8 is a flow chart of an API invoking method according to an embodiment of the present disclosure.

FIG. 9 is another flow chart of the API invoking method according to an embodiment of the present disclosure.

FIG. 10 is yet another flow chart of the API invoking method according to an embodiment of the present disclosure.

FIG. 11 is still yet another flow chart of the API invoking method according to an embodiment of the present disclosure.

FIG. 12 is still yet another flow chart of the API invoking method according to an embodiment of the present disclosure.

FIG. 13 is a schematic view showing interaction of the API invoking method according to an embodiment of the present disclosure.

FIG. 14 is a schematic view showing a communication apparatus according to an embodiment of the present disclosure.

FIG. 15 is another schematic view showing the communication apparatus according to an embodiment of the present disclosure.

FIG. 16 is a block diagram of a communication apparatus according to an embodiment of the present disclosure.

FIG. 17 is a schematic diagram of a chip according to an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. They are merely examples of apparatuses and methods consistent with some aspects of the present disclosure as recited in the appended claims.

Terms used in the embodiments of the present disclosure are only for the purpose of describing specific embodiments, and shall not be construed to limit the present disclosure. As used in the embodiments of the present disclosure and the appended claims, “a/an” and “the” in a singular form are intended to include plural forms, unless clearly indicated in the context otherwise. It should be understood that, the term “and/or” used herein represents and contains any one of associated listed items and all possible combinations of more than one associated listed items.

It should be understood that terms such as “first,” “second” and “third” may be used in the embodiments of the present disclosure for describing various information, the information should not be limited by these terms. These terms are only used for distinguishing information of the same type from others. For example, first information may also be referred to as second information, and similarly, the second information may also be referred to as the first information, without departing from the scope of the embodiments of the present disclosure. As used herein, the term “if” may be construed to mean “when” or “upon” or “in response to determining” depending on the context.

The embodiments of the present disclosure will be described hereinafter in details, and examples are shown in the drawings. Identical or similar reference numbers represent an identical or similar element. The following embodiments described with reference to the drawings are for illustrative purposes only, but shall not be used to limit the scope of the present disclosure.

For ease of understanding, the terms involved in the embodiments of the present disclosure will be introduced at first.

### 1. CAPIF

The CAPIF includes an API invoking entity, a CCF, an AEF, etc. The AEF may provide one or more APIS.

Usually, the API invoking entity obtains, from the CCF, information about the AEF that provides the API, and directly accesses the AEF.

In order to understand an API invoking method in the embodiments of the present disclosure in a better manner, an applicable communication system will be described hereinafter at first.

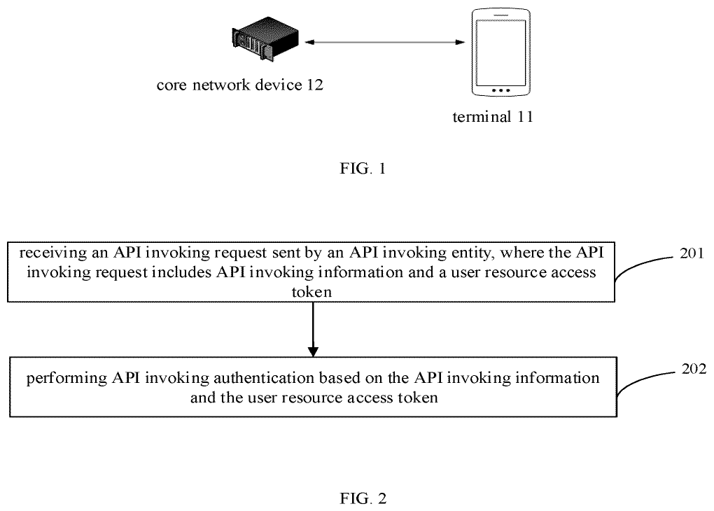

Referring to FIG. 1 which is a schematic diagram of a communication system according to an embodiment of the present disclosure, the communication system includes, but not limited to, one network device and one terminal. Quantities and forms of the devices in FIG. 1 are for illustrative purposes only, but shall not be construed as limiting the embodiments of the present disclosure. In actual use, the communication system may include two or more network devices, and two or more terminals. For example, as shown in FIG. 1, the communication system includes one terminal 11 and one core network device 12.

It should be appreciated that, the technical solutions in the embodiments of the present disclosure may be applied to various communication systems, e.g., a long term evolution (LTE) system, a 5^{th}-generation (5G) mobile communication system, a 5G new radio (NR) system, or any novel mobile communication system that may occur in the future.

The core network device 12 in the embodiments of the present disclosure is a device deployed in a core network, and it mainly functions as to provide a user connection, manage users and bear services. As a bearer network, it provides an interface to an external network. For example, the core network device in the 5G NR system includes an access and mobility management function (AMF) network element, a user plane function (UPF) network element, a session management function (SMF) network element, etc.

For example, the core network device 12 in the embodiments of the present disclosure includes a location management function (LMF) network element. Optionally, the LMF network element includes a location server, and the location server may be implemented as any one of an LMF, an enhanced serving mobile location center (E-SMLC), secure user plane location (SUPL), or SUPL location platform (SLP).

In the embodiments of the present disclosure, the terminal 11 is an entity at a user side for receiving or sending a signal, e.g., a mobile phone. The terminal may also be called as terminal device, user equipment (UE), mobile station (MS), mobile terminal (MT), etc. The terminal may be a vehicle having a communication function, a smart vehicle, a mobile phone, a wearable device, a pad, a computer having a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. In the embodiments of the present disclosure, a specific technology adopted by the terminal and a specific device form thereof will not be particularly defined.

It should be appreciated that, the communication system described herein is used to describe the technical solutions in the embodiments of the present disclosure in a clearer manner, but shall not be construed as limiting the technical solutions. It is obvious for a person skilled in the art that, along with the evolution of the system architecture as well as the emergence of new service scenarios, the technical solutions are also applicable to similar technical problems.

An object of the present disclosure is to provide an API invoking method, an API invoking apparatus, a device and a non-transitory computer-readable storage medium, so as to solve the problem in the related art where the API invoking method is of low security.

In an embodiment of the present disclosure, one of the objectives of SNAAPP security study is to obtain authorization from a resource owner. As speculated in TS 22.261, a UE is allowed to provide/revoke an agreement to information shared with a third party (e.g., position or presence). Based on this, the API invoking entity needs to invoke a specific serving API to obtain/modify/set a specific user resource (e.g., position or quality of service (QoS)), and user resource authorization information and API authorization information shall be used simultaneously in an API invoking process. In order to meet the condition that the user resource authorization information and the API authorization information shall be used simultaneously in the API invoking process, the present disclosure provides an API invoking method.

An API invoking method/apparatus/device and a non-transitory computer-readable storage medium provided in the embodiments of the present disclosure will be described hereinafter in details with reference to the drawings.

FIG. 2 is a flow chart of an API invoking method according to an embodiment of the present disclosure, and this method is executed by an AEF entity. As shown in FIG. 2, the API invoking method includes the following steps.

Step 201: an API invoking request sent by an API invoking entity is received, and the API invoking request includes API invoking information and a user resource access token.

In an embodiment of the present disclosure, the API invoking entity may be a UE or an application function (AF). In addition, in another embodiment of the present disclosure, the AEF entity may be an AEF.

In an embodiment of the present disclosure, the API invoking information may include at least one of: a first identity of the API invoking entity; a first resource owner identity (e.g., generic public subscription identifier (GPSI), international mobile subscriber identity (IMSI) or application layer identity (ID)); an identifier of a serving API to be invoked; an identifier of a service to be invoked; or an identifier of a user resource to be accessed (e.g., position).

Further, in an embodiment of the present disclosure, the user resource access token includes one or more of: a CAPIF core function identity (e.g., network function (NF) instance ID or NF ID); an authorization function identity (e.g., NF instance ID or NF ID); a first identity of the AEF entity (e.g., NF instance ID or NF ID); a second identity of the API invoking entity; a second resource owner identity (e.g., GPSI, IMSI or application layer ID); a user resource identifier (e.g., position); or expiration time.

In an embodiment of the present disclosure, the identifier of the service includes at least one of: a service name, a service operation, or operation semantics.

In an embodiment of the present disclosure, before receiving the API invoking request sent by the API invoking entity, the AEF entity needs to perform mutual identity authentication with the API invoking entity, and establishes a secure connection after the mutual identity authentication, so as to ensure a secure interaction process. In an embodiment of the present disclosure, after performing the mutual identity authentication with the AEF entity, the API invoking entity is provided with an authenticated identity, so as to facilitate the subsequent identity authentication performed by the AEF entity on the API invoking entity. The process of establishing a secure network connection will be described in detail in the subsequent embodiments.

In an embodiment of the present disclosure, the user resource access information may include the second resource owner identity, and/or the user resource identifier. The first identity of the API invoking entity and the first resource owner identity in the API invoking information and the second identity of the API invoking entity and the second resource owner identity in the user resource access token will be described in details in the subsequent embodiments.

Step 202: API invoking authentication is performed based on the API invoking information and the user resource access token.

In an embodiment of the present disclosure, in a case that the API invoking authentication is performed based on the API invoking information and the user resource access token, user resource access authentication and the API invoking authentication are performed on the API invoking request based on the API invoking information and the user resource access token, and in a case that the user resource access authentication and the API invoking authentication are both successful, the API invoking request is determined to be authenticated.

In an embodiment of the present disclosure, in a case of different contents in the API invoking request, methods for performing the API invoking authentication based on the API invoking information and the user resource access token may be different too, which will be described in details in the subsequent embodiments.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access information in the user resource access token to perform the API invoking authentication, so as to prevent the occurrence of such a situation where a user resource is directly accessed without being authenticated by a resource owner, thereby to improve the API invoking security.

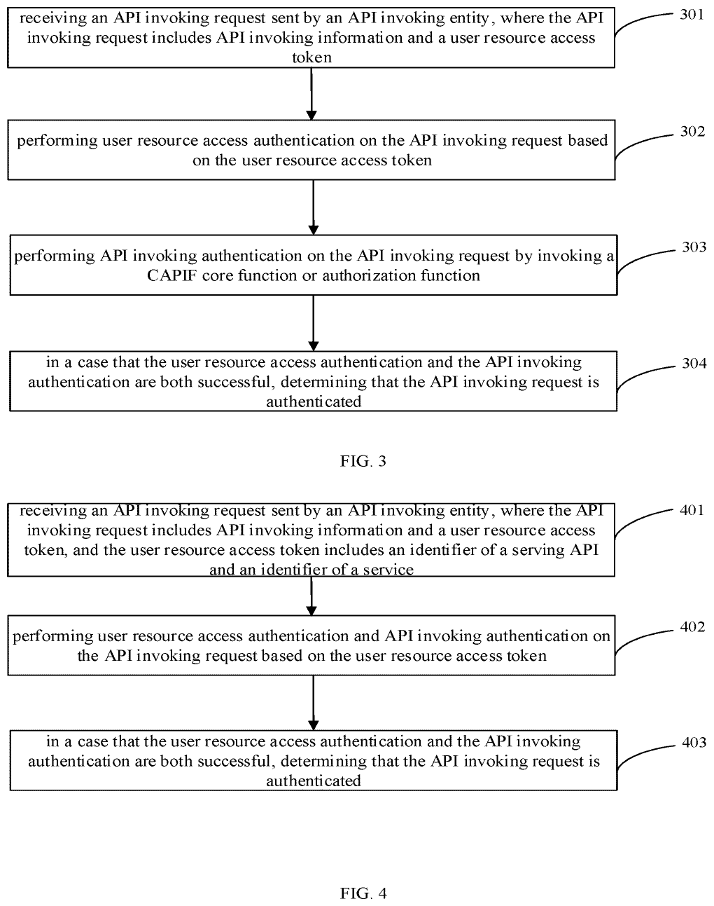

FIG. 3 is a flow chart of an API invoking method according to an embodiment of the present disclosure, and this method is executed by an AEF entity. As shown in FIG. 3, the API invoking method includes the following steps.

Step 301: an API invoking request sent by an API invoking entity is received, and the API invoking request includes API invoking information and a user resource access token.

Step 302: user resource access authentication is performed on the API invoking request based on the user resource access token.

In an embodiment of the present disclosure, a method for performing, by the AEF entity, the user resource access authentication on the API invoking request based on the user resource access token includes: performing validation on the user resource access token, and in a case that the user resource access token is valid, performing the user resource access authentication on the API invoking request based on the user resource access token.

Specifically, in an embodiment of the present disclosure, a method for performing, by the AEF entity, the validation on the user resource access token includes: validating the user resource access token (i.e., whether or not the token is falsified); in a case that the user resource access token is invalid (it means that the user resource access token has been falsified), terminating, by the AEF entity, the subsequent validation and determining that the user resource access authentication fails; and in a case that the user resource access token is valid (it means that the user resource access token is not falsified), completing, by the AEF entity, the validation on the user resource access token and determining that the user resource access token is valid.

In an embodiment of the present disclosure, a method for validating, by the AEF entity, the user resource access token includes: in a case that the user resource access token is a JSON Web token, validating, by the AEF entity, the token using a public key of a CAPIF core function/authorization function (i.e., whether or not the token is falsified); in a case that the user resource access token is not a JSON Web token, sending, by the AEF entity, the user resource access token to the CAPIF core function/authorization function, and receiving an indication from the CAPIF core function/authorization function; in a case that the indication received from the CAPIF core function/authorization function indicates that the user resource access token is valid, determining that the user resource access token is valid; otherwise, determining that the user resource access token is invalid.

It should be appreciated that, in an embodiment of the present disclosure, in the process of validating the user resource access token, the validity of the user resource access token is determined, so as to ensure, through the above validation method, that the information in the received user resource access token is available.

Further, in an embodiment of the present disclosure, after determining that the user resource access token is valid, the AEF entity needs to perform the user resource access authentication on the API invoking request based on the user resource access token.

In an embodiment of the present disclosure, a second resource owner identity and/or a user resource identifier in the user resource access token are user resource access information to be accessed by the API invoking entity. Based on this, the information in the user resource access token to be accessed by the API invoking entity needs to be compared with the information in the API invoking information to be accessed by the API invoking entity, so as to determine whether or not the user resource access authentication on the API invoking request is successful.

In an embodiment of the present disclosure, a method for performing the user resource access authentication on the API invoking request based on the user resource access token includes: determining whether or not a value of a corresponding identity in the user resource access token is the same as a value of the corresponding identity in the API invoking information; if yes, determining that the user resource access authentication on the API invoking request is successful; and if not, determining that the user resource access authentication on the API invoking request is unsuccessful, and terminating, by the AEF entity, the subsequent authentication.

Specifically, in an embodiment of the present disclosure, in a case that a first identity of the API invoking entity in the API invoking information and a second identity of the API invoking entity in the user resource access token are different from, and/or cannot be mapped to, an identifier of the authenticated API invoking entity, the AEF entity terminates the subsequent authentication, and determines that the user resource access authentication on the API invoking request is unsuccessful. In a case that a first resource owner identity in the API invoking information is different from a second resource owner identity in the user resource access token, the AEF entity terminates the subsequent authentication, and determines that the user resource access authentication on the API invoking request is unsuccessful. In a case that an identifier of a user resource to be accessed in the API invoking information is different from an identifier of a user resource to be accessed in the user resource access token, the AEF entity terminates the subsequent authentication, and determines that the user resource access authentication on the API invoking request is unsuccessful. In a case that a first identity of the AEF entity in the user resource access token is different from, or cannot be mapped to, an identity of the AEF entity, the AEF entity terminates the subsequent authentication, and determines that the user resource access authentication on the API invoking request is unsuccessful. Otherwise, the AEF entity determines that the user resource access authentication on the API invoking request is successful.

In an embodiment of the present disclosure, based on the above contents, after determining that the user resource access token is valid, the AEF entity performs authentication on the API invoking entity, and in a case that the first identity of the API invoking entity in the API invoking information and the second identity of the API invoking entity in the user resource access token are the same as, or can be mapped to, the authenticated identity of the API invoking entity, the AEF entity may continue to perform the subsequent authentication. Otherwise, the AEF entity terminates the subsequent authentication, and determines that the user resource access authentication on the API invoking request is unsuccessful. In this way, it is able to determine the identity of the API invoking entity, and prevent the unauthenticated API invoking entity from performing the API invoking, thereby to ensure the API invoking security.

In an embodiment of the present disclosure, based on the above contents, the first identity of the API invoking entity and the first resource owner identity in the API invoking information are used to be compared with the second identity of the API invoking entity and the second resource owner identity in the user resource access token, so as to further determine whether or not the information in the user resource access token is available.

In an embodiment of the present disclosure, in a case that the user resource access authentication on the API invoking request is successful, it means that the API invoking entity is authorized to access the user resource, and in a case that the user resource access authentication on the API invoking request is unsuccessful, it means that the API invoking entity is not authorized to access the user resource.

Step 303: API invoking authentication is performed on the API invoking request by invoking the CAPIF core function/authorization function.

In an embodiment of the present disclosure, the user resource access token includes user resource access information (e.g., the second resource owner identity and/or the user resource identifier) rather than API usage information (e.g., an identifier of a serving API and/or an identifier of a service). Based on this, the AEF entity cannot determine the API usage information capable of being invoked by the API invoking entity based on the user resource access token, and thereby cannot perform the API invoking authentication on the API invoking request based on the user resource access token. At this time, the AEF entity needs to invoke the CAPIF core function or the authorization function to perform the API invoking authentication on the API invoking request.

Specifically, in an embodiment of the present disclosure, a method for performing the API invoking authentication on the API invoking request by invoking the CAPIF core function or the authorization function includes: sending, by the AEF entity, the first identity of the API invoking entity and the identifier of the serving API to be invoked/the identifier of the service to be invoked in the API invoking information to the CCF/AF for API authorization, and determining whether or not the API invoking authentication on the API invoking request is successful based on a response received from the CCF/AF. In a case that an authorization response is received from the CCF/AF, the AEF entity determines that the API invoking authentication on the API invoking request is successful; otherwise, the AEF entity determines that the API invoking authentication on the API invoking request is unsuccessful.

In an embodiment of the present disclosure, in a case that the API invoking authentication on the API invoking request is successful, it means that the API invoking entity is authorized to invoke the serving API and/or service; and in a case that the API invoking authentication on the API invoking request is unsuccessful, it means that the API invoking entity is not authorized to invoke the serving API and/or service.

Step 304: in a case that the user resource access authentication and the API invoking authentication are both successful, the API invoking request is determined to be authenticated.

In an embodiment of the present disclosure, in a case that the user resource access authentication and the API invoking authentication are both successful, the AEF entity determines that the API invoking request is authenticated, and at this time the API invoking entity is authorized to access the user resource and invoke the serving API and/or service. Otherwise, the AEF entity determines that the API invoking request is not authenticated, and at this time the API invoking entity is not authorized to access the user resource and/or invoke the serving API and/or service.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 4 is a flow chart of an API invoking method according to an embodiment of the present disclosure, and this method is executed by an AEF entity. As shown in FIG. 4, the API invoking method includes the following steps.

Step 401: an API invoking request sent by an API invoking entity is received, the API invoking request includes API invoking information and a user resource access token, and the user resource access token includes an identifier of a serving API and an identifier of a service.

Step 402: user resource access authentication and API invoking authentication are performed on the API invoking request based on the user resource access token.

In an embodiment of the present disclosure, a method for performing, by the AEF entity, the user resource access authentication and the API invoking authentication on the API invoking request based on the user resource access token includes: validating the user resource access token, and in a case that the user resource access token is valid, performing the user resource access authentication and the API invoking authentication on the API invoking request based on the user resource access token.

Concerning a method for validating, by the AEF entity, the user resource access token, reference may be made to the relevant description in the above embodiment, and thus will not be particularly defined herein.

In an embodiment of the present disclosure, this embodiment differs from the above embodiment in that, in addition to the information mentioned hereinabove, the user resource access token further includes the identifier of the serving API and/or the identifier of the service. The identifier of the serving API and/or the identifier of the service in the user resource access token are API usage information capable of being accessed by the API invoking entity.

In this regard, in this embodiment of the present disclosure, the user resource access token includes user resource access information and the API usage information. Based on this, after determining that the user resource access token is valid, the AEF entity performs the user resource access authentication and the API invoking authentication on the API invoking request based on the user resource access token.

Specifically, in an embodiment of the present disclosure, a method for performing the user resource access authentication and the API invoking authentication on the API invoking request based on the user resource access token includes: determining whether or not a value of a corresponding identifier in the user resource access token is the same as a value of the corresponding identifier in the API invoking information; if yes, determining that the user resource access authentication and the API invoking authentication on the API invoking request are both successful; otherwise, determining that the user resource access authentication and the API invoking authentication on the API invoking request are unsuccessful, and terminating, by the AEF entity, the subsequent authentication.

Specifically, in an embodiment of the present disclosure, in a case that a first identity of the API invoking entity in the API invoking information and a second identity of the API invoking entity in the user resource access token are different from, and/or cannot be mapped to, an identifier of the authenticated API invoking entity, the AEF entity terminates the subsequent authentication, and determines that the user resource access authentication on the API invoking request is unsuccessful. In a case that a first resource owner identity in the API invoking information is different from a second resource owner identity in the user resource access token, the AEF entity terminates the subsequent authentication, and determines that the user resource access authentication on the API invoking request is unsuccessful. In a case that an identifier of a user resource to be accessed in the API invoking information is different from an identifier of a user resource to be accessed in the user resource access token, the AEF entity terminates the subsequent authentication, and determines that the user resource access authentication on the API invoking request is unsuccessful. In a case that a first identity of the AEF entity in the user resource access token is different from, or cannot be mapped to, an identity of the AEF entity, the AEF entity terminates the subsequent authentication, and determines that the user resource access authentication on the API invoking request is unsuccessful. Otherwise, the AEF entity determines that the user resource access authentication on the API invoking request is successful.

In an embodiment of the present disclosure, in a case that the identifier of the serving API to be invoked in the API invoking information is different from the identifier of the serving API in the user resource access token, the AEF entity terminates the subsequent authentication, and determines that the API invoking authentication on the API invoking request is unsuccessful. In a case that the identifier of the service to be invoked in the API invoking information is different from the identifier of the service in the user resource access token, the AEF entity terminates the subsequent authentication, and determines that the API invoking authentication on the API invoking request is unsuccessful. Otherwise, the AEF entity determines that the API invoking authentication on the API invoking request is successful.

Step 403: in a case that the user resource access authentication and the API invoking authentication are both successful, the API invoking request is determined to be authenticated.

Concerning detailed description about Step 403, reference may be made to relevant description in the above embodiment, and thus will not be particularly defined herein.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

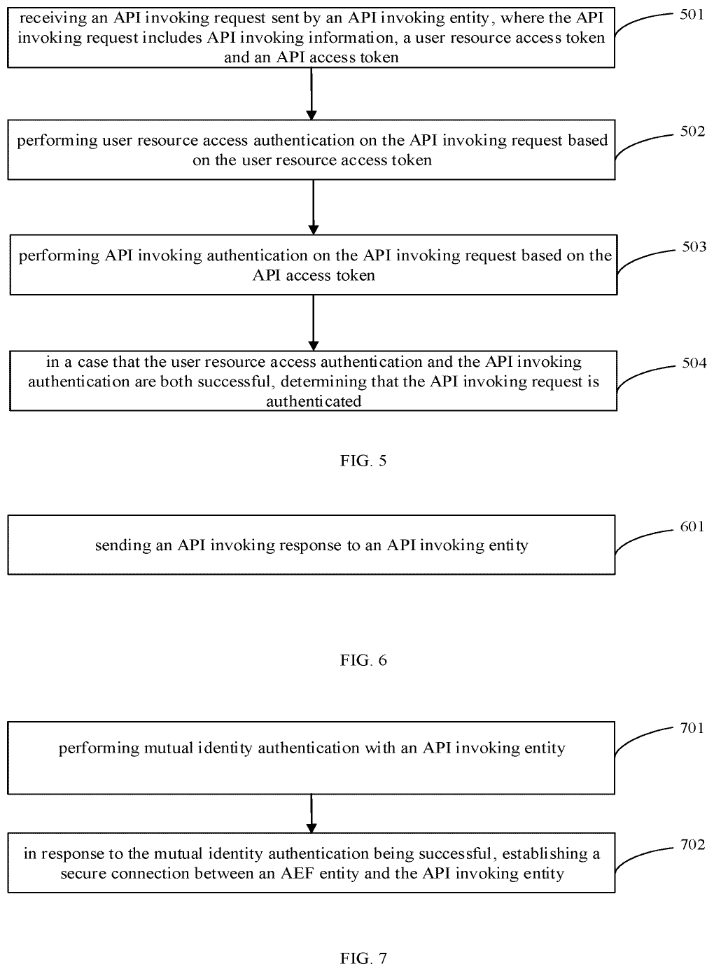

FIG. 5 is a flow chart of an API invoking method according to an embodiment of the present disclosure, and this method is executed by an AEF entity. As shown in FIG. 5, the API invoking method includes the following steps.

Step 501: an API invoking request sent by an API invoking entity is received, and the API invoking request includes API invoking information, a user resource access token, and an API access token.

In an embodiment of the present disclosure, the API access token includes one or more of: a third identity of the API invoking entity; a second identity of the AEF entity; a user resource identifier; an identifier of a serving API; or an identifier of a service.

In an embodiment of the present disclosure, the user resource access token and the API access token are different tokens or the same token.

Step 502: user resource access authentication is performed on the API invoking request based on the user resource access token.

Concerning detailed description about Step 502, reference may be made to the relevant description in the above embodiment, and thus will not be particularly defined herein.

Step 503: API invoking authentication is performed on the API invoking request based on the API access token.

In an embodiment of the present disclosure, a method for performing, by the AEF entity, the API invoking authentication on the API invoking request based on the API access token includes: performing validation on the API access token, and in a case that the API access token is valid, performing the API invoking authentication on the API invoking request based on the API access token.

Specifically, in an embodiment of the present disclosure, a method for performing, by the AEF entity, the validation on the API access token includes: validating the API access token (i.e., whether or not the token is falsified); in a case that the API access token is invalid (it means that the API access token has been falsified), terminating, by the AEF entity, the subsequent authentication, and determining that the API invoking authentication is unsuccessful; and in a case that the API access token is valid (it means that the API access token is not falsified), completing the validation on the API access token and determining that the API access token is valid.

In an embodiment of the present disclosure, a method for validating, by the AEF entity, the API access token includes: in a case that the API access token is a JSON Web token, validating, by the AEF entity, the token using a public key of a CAPIF core function/authorization function; in a case that the user resource access token is not a JSON Web token, sending, by the AEF entity, the API access token to the CAPIF core function/authorization function, and receiving an indication from the CAPIF core function/authorization function; in a case that the indication received from the CAPIF core function/authorization function indicates that the API access token is valid, determining that the API access token is valid; otherwise, determining that the API access token is invalid.

In an embodiment of the present disclosure, in a case that the user resource access token and the API access token are different tokens, after the API invoking entity sends the user resource access token and the API access token to the AEF entity, the AEF entity needs to authenticate both the user resource access token and the API access token.

In another embodiment of the present disclosure, in a case that the user resource access token and the API access token are the same token, after the API invoking entity sends the user resource access token and the API access token to the AEF entity, the AEF entity merely needs to perform the validation on one of the user resource access token and the API access token. Concerning a validation method, reference may be made to relevant description in the above embodiment.

Further, in an embodiment of the present disclosure, in a case that the API access token is valid, the AEF entity further needs to perform the API invoking authentication on the API invoking request based on the API access token.

In an embodiment of the present disclosure, an identifier of a serving API and/or an identifier of a service in the API access token are API usage information capable of being invoked by the API invoking entity, and a user resource identifier in the API access token is user resource access information capable of being accessed by the API invoking entity. Based on this, the API usage information capable of being invoked by the API invoking entity and the user resource access information in the API access token need to be compared with API usage information to be invoked by the API invoking entity and user resource access information in the API invoking information, so as to determine whether or not the API invoking authentication on the API invoking request is successful.

In an embodiment of the present disclosure, a method for performing the user resource access authentication on the API invoking request based on the API access token includes: determining whether or not a value of a corresponding identifier in the API access token is the same as a value of the corresponding identifier in the API invoking information; if yes, determining that the API invoking authentication on the API invoking request is successful; and otherwise, determining the API invoking authentication on the API invoking request is unsuccessful, and terminating, by the AEF entity, the subsequent authentication.

Specifically, in an embodiment of the present disclosure, in a case that a first identity of the API invoking entity in the API invoking information and a third identity of the API invoking entity in the API access token are different from, and/or cannot be mapped to, an identifier of the authenticated API invoking entity, the AEF entity terminates the subsequent authentication, and determines that the API invoking authentication on the API invoking request is unsuccessful. In a case that an identifier of the serving API to be invoked in the API invoking information is different from an identifier of a serving API in the API access token, the AEF entity terminates the subsequent authentication, and determines that the API invoking authentication on the API invoking request is unsuccessful. In a case that a second identity of the AEF entity in the API access token is different from, and/or cannot be mapped to, an identity of the AEF entity, the AEF entity terminates the subsequent authentication, and determines that the API invoking authentication on the API invoking request is unsuccessful. In a case that an identifier of a user resource to be accessed in the API invoking information is different from an identifier of a user resource in the API access token, the AEF entity terminates the subsequent authentication, and determines that the API invoking authentication on the API invoking request is unsuccessful. Otherwise, the AEF entity determines that the API invoking authentication on the API invoking request is successful.

Step 504: in a case that the user resource access authentication and the API invoking authentication are both successful, the API invoking request is determined to be authenticated.

Concerning detailed description about Step 504, reference may be made to the relevant description in the above embodiment, and thus will not be particularly defined herein.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 6 is a flow chart of an API invoking method according to an embodiment of the present disclosure, and this method is executed by an AEF entity. As shown in FIG. 6, the API invoking method includes the following step.

Step 601: an API invoking response is sent to an API invoking entity.

In an embodiment of the present disclosure, the AEF entity sends the API invoking response to the API invoking entity based on a result of the API invoking authentication obtained in the above embodiment.

Specifically, in an embodiment of the present disclosure, in a case that the API invoking request is authenticated, it means that the API invoking entity is authorized to access the user resource and invoke the serving API and/or service, so the AEF entity sends an API invoking authorization response to the API invoking entity; and in a case that the API invoking request fails to be authenticated, it means that the API invoking entity is not authorized to access the user resource and/or invoke the serving API and/or service, so the AEF entity sends an API invoking rejection/termination response to the API invoking entity.

In an embodiment of the present disclosure, after the AEF entity has sent to the API invoking response to the API invoking entity, the API invoking entity performs a corresponding operation based on the received API invoking response.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 7 is a flow chart of an API invoking method according to an embodiment of the present disclosure, and this method is executed by an AEF entity. As shown in FIG. 7, the API invoking method includes the following steps.

Step 701: the AEF entity performs mutual identity authentication with an API invoking entity.

In an embodiment of the present disclosure, the mutual identity authentication is performed with the API invoking entity via any one of the following authentication mechanisms: transport layer security-pre-shared key (TLS-PSK); public key infrastructure (PKI); open authorization (OAuth) license; a general bootstrapping architecture (GBA)-based authentication mechanism; an application layer authentication and key management (AKMA)-based authentication mechanism; or a license-based authentication mechanism.

Step 702: in response to the mutual identity authentication being successful, a secure connection is established between the API invoking entity and the AEF entity.

In an embodiment of the present disclosure, in response to the mutual identity authentication being successful, the secure connection is established between the API invoking entity and the AEF entity via transport layer security (TLS).

In an embodiment of the present disclosure, after the establishment of the secure connection with the API invoking entity, the AEF entity performs interaction with the API invoking entity via the secure connection, e.g., receiving the API invoking request sent by the API invoking entity, or sending the API invoking response to the API invoking entity.

In addition, concerning other detailed description, reference may be made to that in the above embodiment.

In a word, in the API invoking method provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

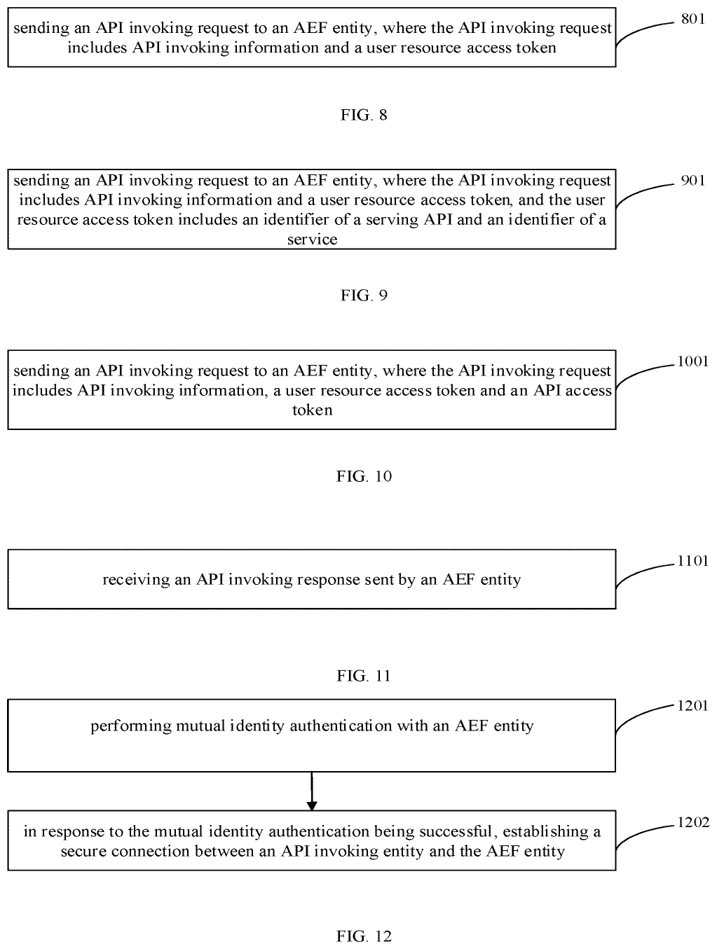

FIG. 8 is a flow chart of an API invoking method according to an embodiment of the present disclosure, and this method is executed by an API invoking entity. As shown in FIG. 8, the API invoking method includes the following step.

Step 801: an API invoking request is sent to an AEF entity, and the API invoking request includes API invoking information and a user resource access token.

In an embodiment of the present disclosure, the API invoking entity is a UE or an AF.

In an embodiment of the present disclosure, the API invoking information includes one or more of: a first identity of the API invoking entity; a first resource owner identity (e.g., GPSI, IMSI, or application layer ID); an identifier of a serving API to be invoked; an identifier of a service to be invoked; or an identifier of a user resource to be accessed (e.g., position).

Further, in an embodiment of the present disclosure, the user resource access token includes one or more of: a CAPIF core function identity (e.g., NF instance ID or NF ID); an authorization function identity (e.g., NF instance ID or NF ID); an identifier of the AEF entity (e.g., NF instance ID or NF ID); a second identity of the API invoking entity; a second resource owner identity (e.g., GPSI, IMSI, or application layer ID); a user resource identifier (e.g., position); or expiration time.

Further, in an embodiment of the present disclosure, after the API invoking entity sends the API invoking request to the AEF entity, the AEF entity performs API invoking authentication based on the API invoking information and the user resource access token.

Concerning other detailed description, reference may be made to that in the above embodiment.

In a word, in the API invoking method provided in the embodiment of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 9 is a flow chart of an API invoking method according to an embodiment of the present disclosure, and this method is executed by an API invoking entity. As shown in FIG. 9, the API invoking method includes the following step.

Step 901: an API invoking request is sent to an AEF entity, the API invoking request includes API invoking information and a user resource access token, and the user resource access token includes an identifier of a serving API and an identifier of a service.

In an embodiment of the present disclosure, this embodiment differs from the above embodiment as shown in FIG. 8 in that, in addition to the above information, the user resource access token further includes the identifier of the serving API and/or the identifier of the service.

In this regard, the contents in the user resource access token in this embodiment are different from those in the above embodiment in FIG. 8. Based on the above, a method for subsequently performing, by the AEF entity, the API invoking authentication based on the API invoking information and the user resource access token may be different too. Concerning detailed description about this part, reference may be made to the relevant description in the above embodiment, and thus will not be particularly defined herein.

In addition, concerning other detailed description about this embodiment, reference may be made to that in the above-mentioned embodiment.

In a word, in the API invoking method provided in the embodiment of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 10 is a flow chart of an API invoking method according to an embodiment of the present disclosure, and this method is executed by an API invoking entity. As shown in FIG. 10, the API invoking method includes the following step.

Step 1001: an API invoking request is sent to an AEF entity, and the API invoking request includes API invoking information, a user resource access token and an API access token.

In an embodiment of the present disclosure, the API access token includes one or more of: a third identity of the API invoking entity; an identifier of a serving API; or an identifier of a service.

In an embodiment of the present disclosure, the user resource access token and the API access token are different tokens or the same token.

In an embodiment of the present disclosure, in a case that the user resource access token and the API access token are different tokens, after the API invoking entity sends the user resource access token and the API access token to the AEF entity, the AEF entity needs to authenticate both the user resource access token and the API access token.

In an embodiment of the present disclosure, in a case that the user resource access token and the API access token are the same token, after the API invoking entity sends the user resource access token and the API access token to the AEF entity, the AEF entity merely needs to perform the validation on one of the user resource access token and the API access token. Concerning detailed description about this part, reference may be made to the relevant description in the above embodiment, and thus will not be particularly defined herein.

In addition, concerning other detailed description about this embodiment, reference may be made to that in the above-mentioned embodiment.

In a word, in the API invoking method provided in the embodiment of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 11 is a flow chart of an API invoking method according to an embodiment of the present disclosure, and this method is executed by an API invoking entity. As shown in FIG. 11, the API invoking method includes the following step.

Step 1101: an API invoking response sent by an AEF entity is received.

In an embodiment of the present disclosure, after the API invoking entity sends an API invoking request to the AEF, the AEF performs API invoking authentication on the API invoking request based on API invoking information and a user resource access token, and determines the API invoking response based on an authentication result.

Specifically, in an embodiment of the present disclosure, in a case that the API invoking request fails to be authenticated, the API invoking entity receives an API invoking rejection/termination response sent by the AEF entity; and in a case that the API invoking request is authenticated, the API invoking entity receives an API invoking authorization response sent by the AEF entity.

In an embodiment of the present disclosure, in a case that the API invoking response sent by the AEF entity is the API invoking rejection/termination response, the API invoking entity does not invoke a corresponding serving API and/or service.

In an embodiment of the present disclosure, in a case that the API invoking response sent by the AEF entity is the API invoking authorization response, the API invoking entity may invoke a corresponding serving API and/or service.

In addition, concerning other detailed description about this embodiment, reference may be made to that in the above-mentioned embodiment.

In a word, in the API invoking method provided in the embodiment of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

FIG. 12 is a flow chart of an API invoking method according to an embodiment of the present disclosure, and this method is executed by an API invoking entity. As shown in FIG. 12, the API invoking method includes the following steps.

Step 1201: the API invoking entity performs mutual identity authentication with an AEF entity.

In an embodiment of the present disclosure, the mutual identity authentication is performed with the AEF entity via any one of the following authentication mechanisms: TLS-PSK; PKI; OAuth license; a GBA-based authentication mechanism; an AKMA-based authentication mechanism; or a license-based authentication mechanism.

Step 1202: in response to the mutual identity authentication being successful, a secure connection is established between the API invoking entity and the AEF entity.

In an embodiment of the present disclosure, in response to the mutual identity authentication being successful, the API invoking entity establishes the secure connection with the AEF entity via TLS.

In an embodiment of the present disclosure, after the establishment of the secure connection with the AEF entity, the API invoking entity performs interaction with the AEF entity via the secure connection, e.g., sending the API invoking request to the AEF entity, or receiving the API invoking response sent by the AEF entity.

In addition, concerning other detailed description about this embodiment, reference may be made to that in the above-mentioned embodiment.

In a word, in the API invoking method provided in the embodiment of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

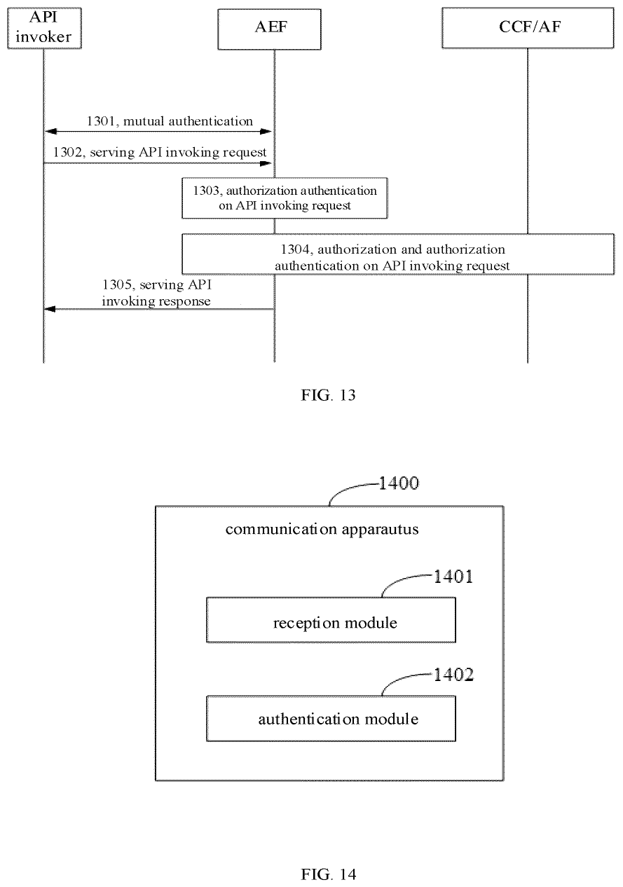

Based on the above, FIG. 13 is a schematic view showing interaction of an API invoking method according to an embodiment of the present disclosure, as shown in FIG. 13, the method specifically includes the following steps.

Step 1301: an API invoker (i.e., the API invoking entity) and an AEF (i.e., the AEF entity) perform mutual authentication (i.e., the mutual identity authentication).

Step 1302: the API invoking entity sends a serving API invoking request (i.e., the API invoking request) to the AEF.

Step 1303: the AEF performs authorization authentication on the API invoking request.

Step 1304: the AEF performs authorization and authorization authentication on the API invoking request via a CAPIF core function/authorization function.

Step 1305: the AEF sends a serving API invoking response (i.e., the API invoking response) to the API invoking entity.

FIG. 14 is a schematic view showing a communication apparatus according to an embodiment of the present disclosure. As shown in FIG. 14, the communication apparatus 1400 includes a reception module 1401 and an authentication module 1402. The reception module 1401 is configured to receive an API invoking request sent by an API invoking entity, and the API invoking request includes API invoking information and a user resource access token. The authentication module 1402 is configured to perform API invoking authentication based on the API invoking information and the user resource access token.

In a word, in the communication apparatus provided in the embodiments of the present disclosure, the AEF entity receives the API invoking request sent by the API invoking entity, and the API invoking request includes the API invoking information and the user resource access token. Then, the AEF entity performs the API invoking authentication based on the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

Optionally, in an embodiment of the present disclosure, the API invoking request further includes an API access token.

Optionally, in an embodiment of the present disclosure, the user resource access token and the API access token are the same token.

Optionally, in an embodiment of the present disclosure, the API invoking information includes one or more of: a first identity of the API invoking entity; a first resource owner identity; an identifier of a serving API to be invoked; an identifier of a service to be invoked; or an identifier of a user resource to be accessed.

Optionally, in an embodiment of the present disclosure, the user resource access token includes one or more of: a CAPIF core function identity; an authorization function identity; an identifier of the AEF entity; a second identity of the API invoking entity; a second resource owner identity; a user resource identifier; or expiration time.

Optionally, in an embodiment of the present disclosure, the user resource access token further includes: an identifier of a serving API; and a service identifier.

Optionally, in an embodiment of the present disclosure, the authentication module 1402 is further configured to: perform user resource access authentication on the API invoking request based on the user resource access token; perform the API invoking authentication on the API invoking request by invoking a CAPIF core function or an authorization function; and in a case that the user resource access authentication and the API invoking authentication are both successful, determine that the API invoking request is authenticated.

Optionally, in an embodiment of the present disclosure, the authentication module 1402 is further configured to: perform user resource access authentication and API invoking authentication on the API invoking request based on the user resource access token; and in a case that the user resource access authentication and the API invoking authentication are successful, determine that the API invoking request is authenticated.

Optionally, in an embodiment of the present disclosure, the authentication module 1402 is further configured to: perform user resource access authentication on the API invoking request based on the user resource access token; perform the API invoking authentication on the API invoking request based on the API access token; and in a case that the user resource access authentication and the API invoking authentication are successful, determine that the API invoking request is authenticated.

Optionally, in an embodiment of the present disclosure, the communication apparatus is further configured to send an API invoking response to the API invoking entity.

Optionally, in an embodiment of the present disclosure, the communication apparatus is further configured to perform mutual identity authentication with the API invoking entity.

Optionally, in an embodiment of the present disclosure, the mutual identity authentication is performed with the API invoking entity via any one of the following authentication mechanisms: TLS-PSK; PKI; OAuth license; a GBA-based authentication mechanism; an AKMA-based authentication mechanism; or a license-based authentication mechanism.

Optionally, in an embodiment of the present disclosure, the communication apparatus is further configured to, in response to the mutual identity authentication being successful, establish a secure connection between the AEF entity and the API invoking entity.

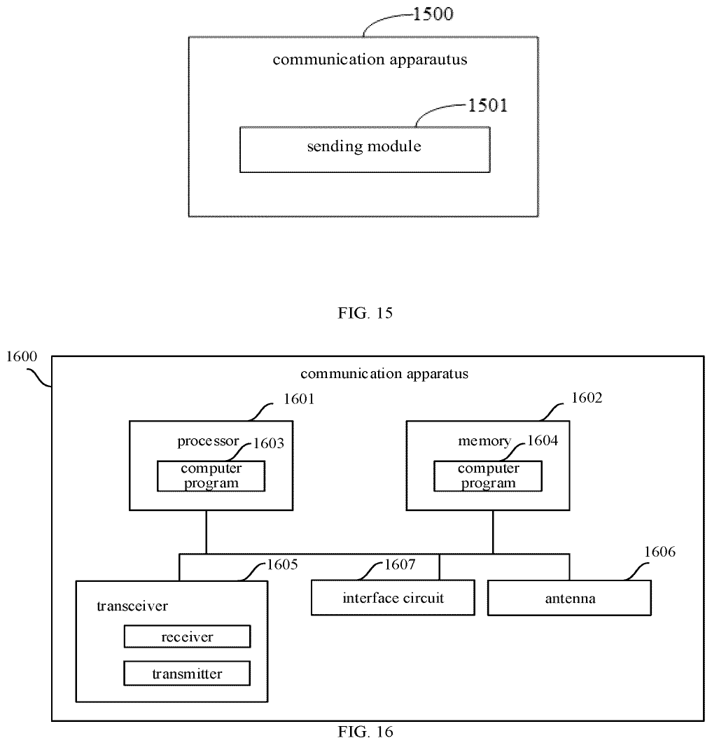

FIG. 15 is a schematic view showing a communication apparatus according to an embodiment of the present disclosure, and as shown in FIG. 15, the communication apparatus 1500 includes a sending module 1501. The sending module 1501 is configured to send an API invoking request to an AEF entity, and the API invoking request includes API invoking information and a user resource access token.

In a word, in the communication apparatus provided in the embodiments of the present disclosure, the API invoking entity sends the API invoking request to the AEF entity, and the API invoking request includes the API invoking information and the user resource access token. In this regard, the AEF entity performs the API invoking authentication via the user resource access token, i.e., the AEF entity uses the user resource access token to determine whether or not the API invoking entity is authorized to access the user resource and invoke the serving API, so as to prevent the occurrence of such a situation where a user resource is directly accessed without being authenticated by a resource owner, thereby to improve the API invoking security.

Optionally, in an embodiment of the present disclosure, the API invoking request further includes an API access token.

Optionally, in an embodiment of the present disclosure, the user resource access token and the API access token are the same token.

Optionally, in an embodiment of the present disclosure, the API invoking information includes one or more of: a first identity of the API invoking entity; a first resource owner identity; an identifier of a serving API to be invoked; an identifier of a service to be invoked; or an identifier of a user resource to be accessed.

Optionally, in an embodiment of the present disclosure, the user resource access token includes one or more of: a CAPIF core function identity; an authorization function identity; an identity of the AEF entity; a second identity of the API invoking entity; a second resource owner identity; a user resource identifier; or expiration time.

Optionally, in an embodiment of the present disclosure, the user resource access token further includes: an identifier of a serving API; and a service identifier.

Optionally, in an embodiment of the present disclosure, the communication apparatus is further configured to receive an API invoking response sent by the AEF entity.

Optionally, in an embodiment of the present disclosure, the communication apparatus is further configured to perform mutual identity authentication with the AEF entity.

Optionally, in an embodiment of the present disclosure, the mutual identity authentication is performed with the AEF entity via any one of the following authentication mechanisms: TLS-PSK; PKI; OAuth license; a GBA-based authentication mechanism; an AKMA-based authentication mechanism; or a license-based authentication mechanism.

Optionally, in an embodiment of the present disclosure, the communication apparatus is further configured to, in response to the mutual identity authentication being successful, establish a secure connection between the API invoking entity and the AEF entity.

FIG. 16 is a block diagram of a communication apparatus 1600 according to an embodiment of the present disclosure. The communication apparatus 1600 may be a network device, or a terminal, or a chip, a chip system or a processor which supports the network device to implement the above-mentioned method, or a chip, a chip system or a processor which supports the terminal to implement the above-mentioned method. The communication apparatus is used to implement the methods in the above-mentioned method embodiments, and concerning the implementation, reference may be made to that mentioned in the above-mentioned method embodiments.

The communication apparatus 1600 may include one or more processors 1601. The processor 1601 may be a general-purpose processor or special-purpose processor, e.g., a baseband processor or a central processing unit. The baseband processor is configured to process a communication protocol as well as communication data, and the central processing unit is configured to control the communication apparatus (e.g., a network side device, a baseband chip, a terminal, a terminal device chip, a Distributed Unit (DU) or a Centralized Unit (CU)), execute a computer program, and process data in the computer program.

Optionally, the communication apparatus 1600 further includes one or more memories 1602 storing therein a computer program 1604. The processor 1601 is configured to execute the computer program 1604, so that the communication apparatus 1600 implements the method in the above-mentioned method embodiments. Optionally, the memory 1602 further stores therein data. The communication apparatus 1600 is arranged independent of, or integrated with, the memory 1602.

Optionally, the communication apparatus 1600 further includes a transceiver 1605 and an antenna 1606. The transceiver 1605 is also called as a transceiver unit, a transceiver machine or a transceiver circuit, and it is configured to achieve a transmission function and a reception function. The transceiver 1605 includes a receiver and a transmitter. The receiver is called as a receiving machine or a reception circuit, and it is configured to achieve the reception function. The transmitter is called as a transmitting machine or a transmission circuit, and it is configured to achieve the transmission function.

Optionally, the communication apparatus 1600 further includes one or more interface circuits 1607. The interface circuit 1607 is configured to receive a code instruction and transmit it to the processor 1601. The processor 1601 executes the code instruction, so that the communication apparatus 1600 implements the method in the above-mentioned method embodiments.

In a case that the communication apparatus 1600 is a terminal, the transceiver 1605 is configured to execute Step 201 in FIG. 2, Step 301 in FIG. 3, Step 401 in FIG. 4, Step 501 in FIG. 5, and Step 601 in FIG. 6. The processor 1601 is configured to execute Step 202 in FIG. 2, Steps 302 to 304 in FIG. 3, Steps 402 and 403 in FIG. 4, Steps 502 to 504 in FIG. 5, and Steps 701 and 702 in FIG. 7.

In a case that the communication apparatus 1600 is a network device, the transceiver 1605 is configured to execute Step 801 in FIG. 8, Step 901 in FIG. 9, Step 1001 in FIG. 10 and Step 1101 in FIG. 11. The processor 1601 is configured to execute Steps 1201 and 1202 in FIG. 12.

In an embodiment of the present disclosure, the processor 1601 may include a transceiver for achieving a reception function and a transmission function. For example, the transceiver is a transceiver circuit, an interface, or an interface circuit. The transceiver circuit, the interface or the interface circuit for achieving the reception function and the transmission function may be arranged separately, or integrated with each other. The transceiver circuit, the interface or the interface circuit is configured to read and write codes/data, or transmit/or transfer signals.

In an embodiment of the present disclosure, the processor 1601 stores therein a computer program 1603, and the computer program 1603 is executed by the processor 1601, so that the communication apparatus 1600 implements the method in the above-mentioned method embodiments. The computer program 1603 may be programmed in the processor 1601, and in this case, the processor 1601 may be implemented through hardware.

In an embodiment of the present disclosure, the communication apparatus 1600 includes a circuit for implementing the transmission, reception or communication function in the above-mentioned method embodiments. The processor and the transceiver described in the embodiments of the present disclosure may be implemented in an Integrated Circuit (IC), an analog IC, a Radio Frequency IC (RFIC), a mixed-signal IC, an Application Specific Integrated Circuit (ASIC), a Printed Circuit Board (PCB) or an electronic device. The processor and the transceiver may also be manufactured through various IC processes, e.g., Complementary Metal Oxide Semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus mentioned hereinabove may be a network device or a terminal device, but the scope of the communication apparatus is not limited thereto. In addition, a structure of the communication apparatus is limited to that in FIG. 16. The communication apparatus may be an independent device, or a part of a large device. For example, the communication apparatus may be: (1) an independent IC, chip, chip system or chip sub-system; (2) a set of one or more ICs (optionally, the IC set also includes a memory member for storing therein data and a computer program; (3) an ASIC, e.g., a Modem; (4) a module capable of being embedded into the other device; (5) a receiver, a terminal device, a smart terminal device, a cellular phone, a wireless device, a handheld device, a mobile unit, a vehicle-mounted device, a network device, a cloud device, an artificial intelligence device, etc. ; or (6) the other device.

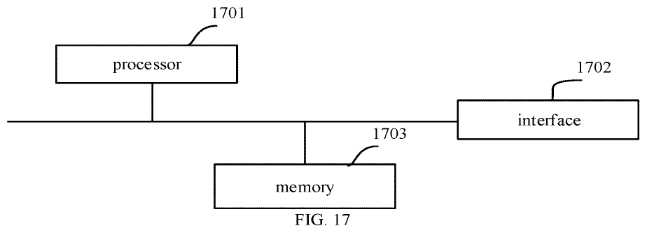

In a case that the communication apparatus is a chip or a chip system, FIG. 17 is a block diagram of the chip according to an embodiment of the present disclosure. As shown in FIG. 17, the chip includes a processor 1701 and an interface 1702. There may exist one or more processors 1701, and more than one interface 1702.

Optionally, the chip further includes a memory 1703 for storing therein necessary computer programs and data.

It should be appreciated that, various illustrative logical blocks and steps listed in the embodiments of the present disclosure may be implemented through electronic hardware, computer software, or a combination thereof. Whether these functions are implemented through hardware or software depends on design requirements on an entire system and specific applications. For each specific application, various methods are used to achieve the function, which however shall not be construed as going beyond the scope of the present disclosure.

The present disclosure further provides in some embodiments a non-transitory computer-readable storage medium storing therein an instruction. The instruction is executed by a computer to achieve the functions in any of the above method embodiments.

The present disclosure further provides in some embodiments a computer program product. The computer program product is executed by a computer to achieve the functions in any of the above method embodiments.

In the above-mentioned embodiments of the present disclosure, all of, or a part of, the modules are implemented in the form of software, hardware, firmware or a combination thereof. When the modules are implemented in the form of software, all of, or a part of, the modules are implemented in the form of a computer program product. The computer program product includes one or more computer programs. When the computer programs are loaded onto and executed by a computer, all of, or a part of, the processes or functions in the embodiments of the present disclosure are generated by the computer. The computer may be a general-purpose computer, a special-purpose computer, a computer network, or any other programmable device. The computer program may be stored in a non-transitory computer-readable storage medium, or transferred from one non-transitory computer-readable storage medium to another non-transitory computer-readable storage medium, e.g., transferred from one website, one computer, one server or one data center to another website, another computer, another server or another data center in a wired manner (e.g., through a co-axial cable, an optical fiber, or a digital subscriber line (DSL)) or a wireless manner (e.g., infrared, cordless or microwave). The non-transitory computer-readable storage medium may be any available medium capable of being accessed by a computer, or a data storage device, e.g., a server or a data center including one or more available mediums. The available medium may be a magnetic medium (e.g., a floppy disc, a hard disc or magnetic tape), an optical medium (e.g., a digital video disc (DVD)), or a semiconductor medium (e.g., a solid state disk (SSD)).

It should be appreciated that, such words as “first” and “second” are used to differentiate the items from each other, but shall not be construed as limiting the scope of the present disclosure or indicating any sequence.

The expression “at least one” is used to indicate one or more, e.g., two, three, four or more, which will not be particularly defined herein. In the embodiments of the present disclosure, for technical features of the same kind, the words “first”, “second”, “third”, “A”, “B”, “C” and “D” are used to differentiate these technical features, without indicating any sequence or sizes thereof.

The correspondence shown in each table in the present disclosure may be configured or predefined. Values of information in each table are for illustrative purposes only, and any other values may also be configured, which will not be particularly defined herein. In a case of configuring the correspondence between the information and parameters, it is not necessary to configure all the correspondences in the table. For example, in the table in the embodiments of the present disclosure, correspondences shown in some rows may not be configured. For another example, appropriate deformation or adjustment may be performed based on the table, e.g., splitting or combination. A name of each parameter in each table may use the other name capable of being understood by the communication apparatus, and a value of the parameter or a presentation mode thereof may also use that capable of being understood by the communication apparatus. During the implementation of each table, the other data structure may also be used, e.g., array, queue, container, stack, linear table, pointer, linked list, tree, map, structure, class, heap, or hash table.

The term “predefined” in the embodiments of the present disclosure may be understood as “defined”, “defined in advance”, “stored”, “pre-stored”, “pre-negotiated”, “preconfigured”, “programmed”or “pre-programed”.

It should be appreciated that, units and algorithm steps for instances described in the embodiments of the present disclosure may be implemented in the form of electronic hardware, or a combination of a computer program and the electronic hardware. Whether or not these functions are executed by hardware or software depends on specific applications or design constraints of the technical solution. Different methods may be adopted with respect to the specific applications so as to achieve the described functions, without departing from the scope of the present disclosure.

It should be further appreciated that, for convenience and clarification, concerning operation procedures of the system, apparatus and units described hereinabove, reference may be made to the corresponding procedures in the method embodiments, and thus will not be particularly defined herein.

The above embodiments are merely for illustrative purposes, but shall not be construed as limiting the scope of the present disclosure. Any person skilled in the art may make modifications and substitutions without departing from the spirit of the present disclosure, and these modifications and substitutions shall also fall within the scope of the present disclosure. Hence, the scope of the present disclosure shall be subject to the scope defined by the appended claims.

1. An application programming interface (API) invoking method, executed by an API exposing function (AEF) entity, comprising:
receiving an API invoking request sent by an API invoking entity, wherein the API invoking request comprises API invoking information and a user resource access token; and
performing API invoking authentication based on the API invoking information and the user resource access token.

2. The method according to claim 1, wherein the API invoking request further comprises an API access token.

3. The method according to claim 2, wherein the user resource access token and the API access token are a same token.

4. The method according to claim 1, wherein the API invoking information comprises one or more of:
a first identity of the API invoking entity;
a first resource owner identity;
an identifier of a serving API to be invoked;
an identifier of a service to be invoked; or
an identifier of a user resource to be accessed.

5. The method according to claim 1, wherein the user resource access token comprises one or more of:
a common application programming interface framework (CAPIF) core function identity;
an authorization function identity;
an identity of the AEF entity;
a second identity of the API invoking entity;
a second resource owner identity;
a user resource identifier;
expiration time;
an identifier of a serving API; or
a service identifier.

6. (canceled)

7. The method according to claim 1, wherein the performing the API invoking authentication based on the API invoking information and the user resource access token comprises:
performing user resource access authentication on the API invoking request based on the user resource access token;
performing the API invoking authentication on the API invoking request by invoking a CAPIF core function or an authorization function; and
in a case that the user resource access authentication and the API invoking authentication are both successful, determining that the API invoking request is authenticated.

8. The method according to claim 6, wherein the performing the API invoking authentication based on the API invoking information and the user resource access token comprises:
performing user resource access authentication and the API invoking authentication on the API invoking request based on the user resource access token; and
in a case that the user resource access authentication and the API invoking authentication are both successful, determining that the API invoking request is authenticated.

9. The method according to claim 2, wherein the performing the API invoking authentication based on the API invoking information and the user resource access token comprises:
performing user resource access authentication on the API invoking request based on the user resource access token;
performing the API invoking authentication on the API invoking request based on the API access token; and
in a case that the user resource access authentication and the API invoking authentication are both successful, determining that the API invoking request is authenticated.

10. The method according to claim 1, further comprising at least one of:
sending an API invoking response to the API invoking entity; or
performing mutual identity authentication with the API invoking entity.

11. (canceled)

12. The method according to claim 10, wherein the method further comprises: performing the mutual identity authentication with the AEF entity, and the mutual identity authentication is performed with the API invoking entity with any one of the following authentication mechanisms:
transport layer security-pre-shared key (TLS-PSK);
public key infrastructure (PKI);
an open authorization (OAuth) license;
a general bootstrapping architecture (GBA)-based authentication mechanism;
an application layer authentication and key management (AKMA)-based authentication mechanism; or
a license-based authentication mechanism.

13. The method according to claim 10, further comprising:
performing the mutual identity authentication with the AEF entity; and
in response to the mutual identity authentication being successful, establishing a secure connection between the AEF entity and the API invoking entity.

14. An API invoking method, executed by an API invoking entity, comprising:
sending an API invoking request to an AEF entity, wherein the API invoking request comprises API invoking information and a user resource access token.

15. The method according to claim 14, wherein the API invoking request further comprises an API access token.

16. The method according to claim 15, wherein the user resource access token and the API access token are a same token.

17. The method according to claim 14, wherein the API invoking information comprises one or more of:
a first identity of the API invoking entity;
a first resource owner identity;
an identifier of a serving API to be invoked;
an identifier of a service to be invoked; or
an identifier of a user resource to be accessed.

18. The method according to claim 14, wherein the user resource access token comprises one or more of:
a CAPIF core function identity;
an authorization function identity;
an identity of the AEF entity;
a second identity of the API invoking entity;
a second resource owner identity;
a user resource identifier;
expiration time;
an identifier of a serving API; or
a service identifier.

19. (canceled)

20. The method according to claim 14, further comprising at least one of:
receiving an API invoking response sent by the AEF entity; or
performing mutual identity authentication with the AEF entity.

21. (canceled)

22. The method according to claim 20, wherein the method further comprises: performing the mutual identity authentication with the AEF entity, and at least one of:
the mutual identity authentication is performed with the AEF entity with any one of the following authentication mechanisms: TLS-PSK; PKI; an OAuth license; a GBA-based authentication mechanism; an AKMA-based authentication mechanism; or a license-based authentication mechanism; or
the method further comprises: in response to the mutual identity authentication being successful, establishing a secure connection between the API invoking entity and the AEF entity.

23-25. (canceled)

26. A communication apparatus, comprising a processor and a memory, wherein the memory is configured to store therein a computer program, and the processor is configured to:
receive an application programming interface (API) invoking request sent by an API invoking entity, wherein the API invoking request comprises API invoking information and a user resource access token; and
perform API invoking authentication based on the API invoking information and the user resource access token.

27-28. (canceled)

29. A communication apparatus, comprising a processor and a memory, wherein the memory is configured to store therein a computer program, and the processor is configured to execute the computer program in the memory to implement the method according to claim 14.
